(19) United States
(12) Patent Application Publication
(10) Pub. No.: US 2008/0109799 A1
(43) Pub. Date: May 8, 2008

(54) INFORMATION PROCESSING METHOD AND RECORDING MEDIUM

(75) Inventor: Nobuyuki Imamura, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/936,218

(22) Filed: Nov. 7, 2007

Related U.S. Application Data
(60) Provisional application No. 60/864,698, filed on Nov. 7, 2006.

(51) Int. Cl. G06F 9/44

(52) U.S. Cl. 717/168

(57) ABSTRACT

An information processing method for an information processing apparatus which acquires a software component controlling an image forming apparatus from an external device and updates the software component, wherein the software component is classified by function unit of the image forming apparatus, and the function unit is caused to correspond to information specifying a device of the image forming apparatus and a user, the method includes sending information to univocally identify the software component to the external device, acquiring information about a software component to be a subject of update from the external device, sending information about a software component selected from the software components corresponding to the acquired information to the external device, acquiring software component data sent from the external device in accordance with the information about the selected software component, and updating the corresponding software component of the image forming apparatus, using the acquired software component data.

### CROSS-REFERENCE TO RELATED APPLICATIONS

This application claims the benefit of U.S. Provisional Application No. 60/864,698, filed Nov. 7, 2006.

### BACKGROUND OF THE INVENTION

1. Field of the Invention

The present invention relates to an information processing method which enables flexible updating of software, and a recording medium.

2. Description of the Related Art

As user's preference has been diversified recently, the importance of so-called customization is important, by which the user uses only a desired function. It also applies to software which controls an MFP. In the software which controls an MFP (including external and internal control), availability of customization according to various demands by the user is a particularly important element. This is because in an environment where plural MFPs are installed as in an office environment, not only the machine types of the MFPs but also the MFP functions which the user wants to use are varied.

In this manner, in the software which controls an MFP, since the functions which the user wants to use vary, it is important to provide a mechanism which can flexibly cope with customization of the software. Traditionally, mechanisms have been provided to change software with respect to a function dependent on machine type on the basis of machine type information when upgrading the version of the software installed in the device.

In the technique disclosed in JP-A-2004-227529, the version confirming unit compares the version of the stored printer driver with the version of the printer driver stored in an external file server. If the printer driver stored in the external file server is newer, the new printer driver is acquired by accessing the file server.

In the technique disclosed in JP-A-2002-222068, information of the latest version of firmware corresponding to the machine type of the local device which is registered to the central control device is acquired, and it is compared with the current version of the firmware of the local device, thereby checking whether there is version update. If it is recognized that there is version update, the new firmware is downloaded and saved from the central control device.

### BRIEF SUMMARY OF THE INVENTION

An information processing method according to a first aspect of the invention is an information processing method for an information processing apparatus which acquires a software component controlling an image forming apparatus from an external device via a communication line and updates the software component, wherein the software component is classified by function unit of the image forming apparatus, and the function unit is caused to correspond to information specifying a device of the image forming apparatus and information specifying a user using the image forming apparatus, the method comprising: sending information to univocally identify the software component to the external device, acquiring information about a software component to be a subject of update on the basis of the information to univocally identify the software component from the external device, sending information about a software component selected from the software components corresponding to the acquired information to the external device, acquiring software component data sent from the external device in accordance with the information about the selected software component, and updating the corresponding software component of the image forming apparatus, using the acquired software component data.

An information processing method according to a second aspect of the invention is an information processing method for an information processing apparatus which acquires a software component controlling an image forming apparatus from an external device via a communication line and updates the software component, wherein the software component is classified by function unit of the image forming apparatus, and the function unit is caused to correspond to information specifying a device of the image forming apparatus and information specifying a user using the image forming apparatus, the method comprising: sending the information specifying the device of the image forming apparatus to the external device, sending version of a software component in response to an inquiry about the version of the software component specified in the external device on the basis of the information specifying the device, acquiring information about a software component to be a subject of update which is further specified in the external device on the basis of the version from the external device, sending information about a software component selected from the software components corresponding to the acquired information to the external device, acquiring software component data sent from the external device, and updating the corresponding software component of the image forming apparatus using the acquired software component data.

An information processing method according to a third aspect of the invention is an information processing method for an information processing apparatus which acquires a software component controlling an image forming apparatus from an external device via a communication line and updates the software component, wherein the software component is classified by function unit of the image forming apparatus, and the function unit is caused to correspond to information specifying a device of the image forming apparatus and information specifying a user using the image forming apparatus, the method comprising: sending the information specifying the user using the image forming apparatus to the external device, sending version of a software component, in response to an inquiry about the version of the software component specified in the external device on the basis of the information specifying the user, acquiring information about a software component to be a subject of update which is further specified in the external device on the basis of the version from the external device, sending information about a software component selected from the software components corresponding to the acquired information to the external device, acquiring software component data sent from the external device, and updating the corresponding software component of the image forming apparatus using the acquired software component data.

A recording medium according to a fourth aspect of the invention is a recording medium having recorded therein an information processing program for an information processing apparatus which acquires a software component controlling an image forming apparatus from an external device via a communication line and updates the software component, wherein the software component is classified by function unit of the image forming apparatus, and the function unit is caused to correspond to information specifying a device of the image forming apparatus and information specifying a user using the image forming apparatus, the program causing the image forming apparatus to execute the steps of: sending information to univocally identify the software component to the external device; acquiring information about a software component to be a subject of update on the basis of the information to univocally identify the software component from the external device; sending information about a software component selected from the software components corresponding to the acquired information to the external device; acquiring software component data sent from the external device in accordance with the information about the selected software component; and updating the corresponding software component of the image forming apparatus using the acquired software component data.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a configuration of an information processing system to which an information processing method according to a first embodiment of the invention is applied.

FIG. 2 is a view showing exemplary software components classified by function unit for controlling an MFP.

FIG. 3 is a view showing detailed exemplary software components for controlling an MFP.

FIG. 4 is a flowchart showing procedures for updating the version of software by the information processing method according to the first embodiment of the invention.

FIG. 5 is a flowchart showing procedures for updating the version of software by an information processing method according to a second embodiment of the invention.

FIG. 6 is a view showing versions of software components.

FIG. 7 is a flowchart showing procedures for updating the version of software by an information processing method according to a modification of the second embodiment of the invention.

FIG. 8 is a flowchart showing procedures for updating the version of software by an information processing method according to a third embodiment of the invention.

FIG. 9 is a view showing software components available to each user as an MFP.

FIG. 10 is a flowchart showing procedures for updating the version of software by an information processing method according to a fourth embodiment of the invention.

FIG. 11 is a view showing an example in which a user interface is changed.

FIG. 12 is a view showing a representative flow of updating the version of software.

### DETAILED DESCRIPTION OF THE INVENTION

Hereinafter, an information processing method according to a first embodiment of the invention will be described with reference to the accompanying drawings.

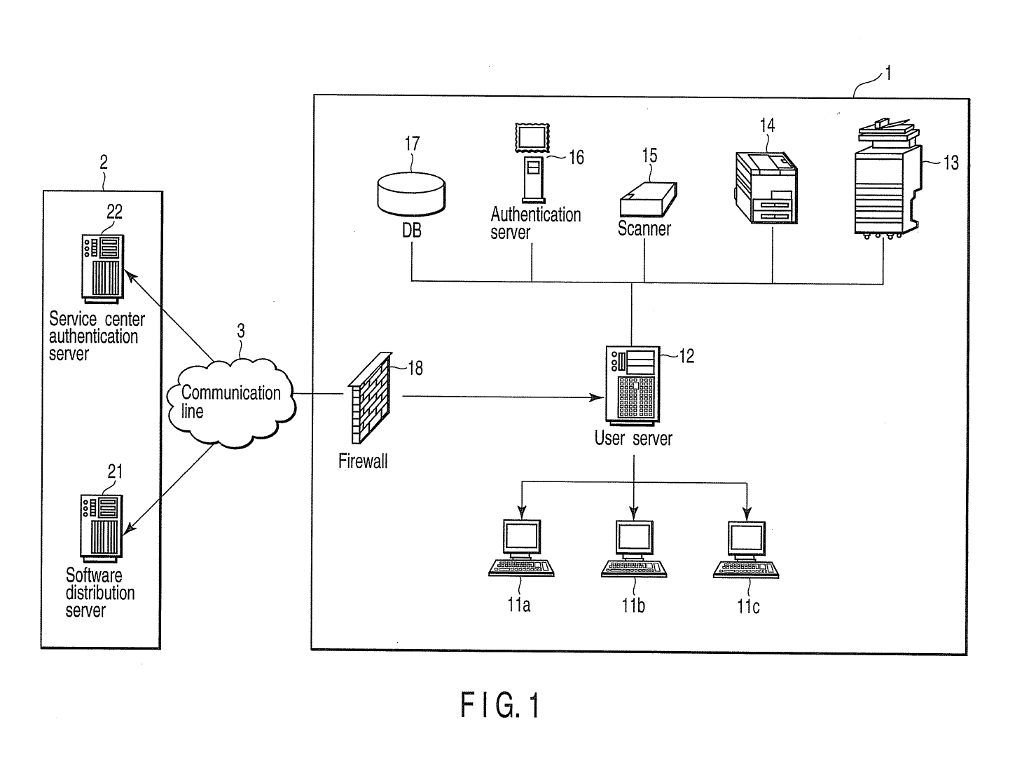

FIG. 1 is a view schematically showing a configuration of an information processing system to which the information processing method according to the first embodiment of the invention is applied. This information processing system includes an office 1 and a service center 2 which are connected with each other via a communication line 3.

The office 1 is provided with plural personal computers (PCs) 11a, 11b and 11c, a user server 12, a multi-function peripheral (MFP) 13, a high-speed monochrome printer 14, a scanner 15, a user authentication server 16, a database 17, and a firewall 18. These devices are connected to a network such as a LAN. Moreover, the user server 12 is connected to the communication line 3 via the firewall 18.

The user authentication server 16 manages authentication data about users. In the database 17, scanned image files, document files, user information, device information, software information and so on are saved. The user server 12 collectively controls signal transmitting operations between these PCs and devices, and also controls update of the version of software incorporated in each device.

The service center 2 has a software distribution server 21 and a service center authentication server 22. The software distribution server 21 manages the version of the software incorporated in the entire MFP 13 and also saves the software. The service center authentication server 22 manages authentication data with respect to all users. Then, the software distribution server 21 and the service center authentication server 22 are connected to the communication line 3.

As described above, the user server 12 collectively controls signal transmitting operations between the PCs and the devices. For example, when the user server 12 has received a copy instruction signal to the MFP 13 from the PC, the user server 12 converts the signal to a signal controlling copy operation of the MFP 13 and sends it to the MFP 13. Also, in accordance with an instruction from the PC, the user server 12 outputs a file saved in the DB 17 to the laser printer 14 and saves image data read by the scanner 15, into the DB 17.

Moreover, the user server 12 sends and receives information to and from the service center 2 via the communication line 3, downloads version update software, and controls version update operation for the software of each device. In this case, the user server 12 acquires data about users from the user authentication server 16, or gathers information about each device from the device, information about the version of software which controls the device, and so on, and sends the information to the service center 2.

On the other hand, at the service center 2, the software distribution server 21 sends and receives information to and from the service center authentication server 22 on the basis of the data sent from the office 1, and extracts software to be a subject of version update. Of the extracted software, the software requested by the office is sent to the user server 12.

Next, the operation of updating the version of software using this information processing system will be described. In the following description, the operation of updating the version of software which controls the MFP 13 is described as an example. However, the invention of the present application is not limited this embodiment and can also be applied to the operation of updating the version of software of the other devices.

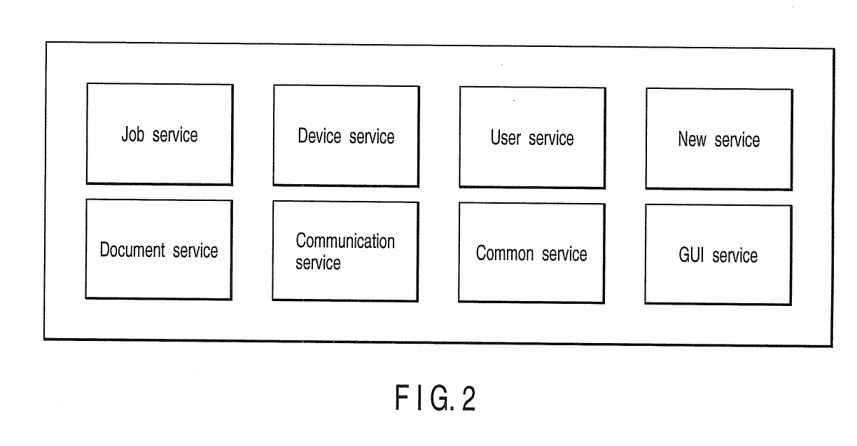

FIG. 2 is a view showing exemplary software components classified by function unit for controlling the MFP 13. These software components may be installed in the user server 12 or may be incorporated in the MFP 13.

“Job Service” is a software component to operate jobs of the MFP 13 such as copy, scan, fax, and print. “Device Service” is a software component to operate information managed within the device such as counter, log, and serial number of the device. “User Service” is a software component to operate authority to use the device and its related information. “Document Service” is a software component to operate image data managed in the device.

“Communication Service” is a software component to use a measure of communication to operate the MFP 13, for example, a communication measure such as HTTP, FTP, SMTP or the like. “Common Service” is a software component that can be used commonly within this software platform. “GUI Service” is a software component which enables switching of the user interface for each user. “New Service” is a software component provided when a new device has appeared or when a new function has been added in the existing device. This means that a software component provided within this software platform can be flexibly added or deleted for each service.

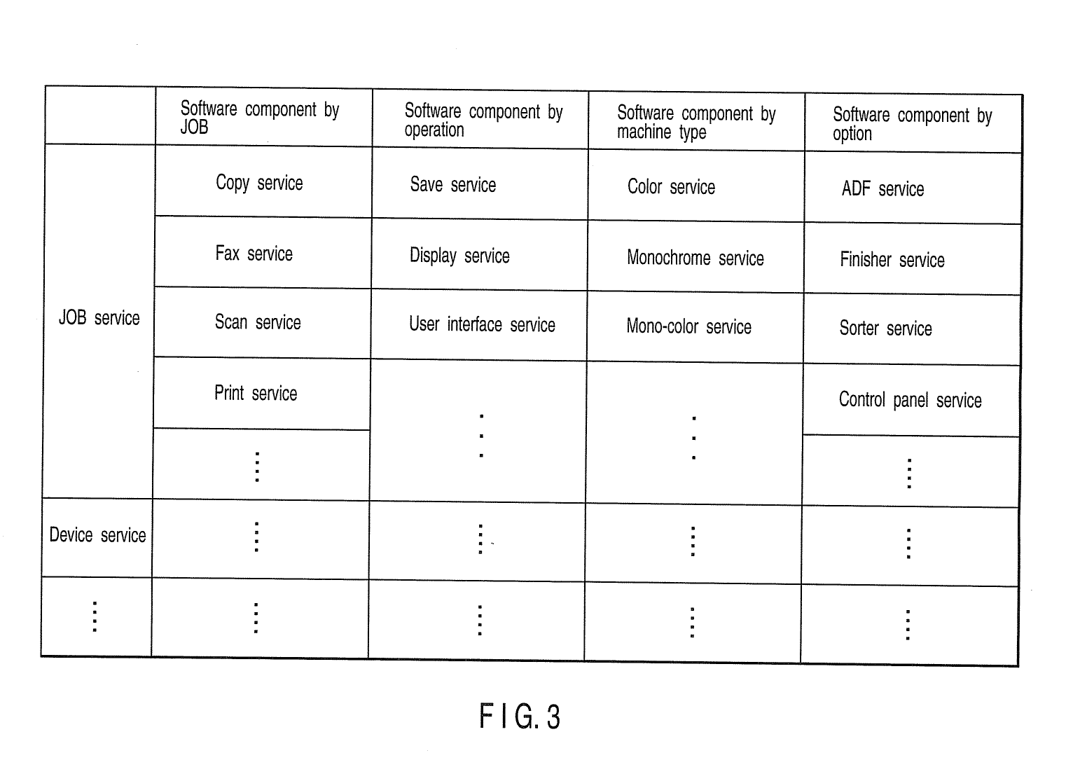

In the present information processing system, the software components of the above groups are further classified in detail by function unit. FIG. 3 is a view showing detailed exemplary software components for controlling the MFP 13.

“Job Service” has its functions classified further into software components by job, software components by operation, software components by machine type, and software components by option.

The software components by job include software components to control each job of the MFP 13 such as copy, scan, fax, and print. The software components by operation include software components to control each operation such as save, display, and user interface. The software components by machine type include software components to control each processing operation such as color, monochrome, and mono-color, which are processing functions held by the MFP 13 of the corresponding machine type. The software components by option include software components to control operation of each optional component provided in accordance with a user's selection, for example, software to control an ADF, finisher, sorter, control panel or the like.

“Job Service” can also be classified in other ways than the above groups. Moreover, the above groups may be further classified. A software component belonging to one group may be included in software components belonging to another group. The other services than “Job Service” similarly have software components which are further classified in detail.

The information about the above software components may be saved in the database 17 as software information, or may be managed by the user server 12 or the MFP 13. This information about the software components includes software version of each software component. Therefore, it has a configuration which enables software management for each software component.

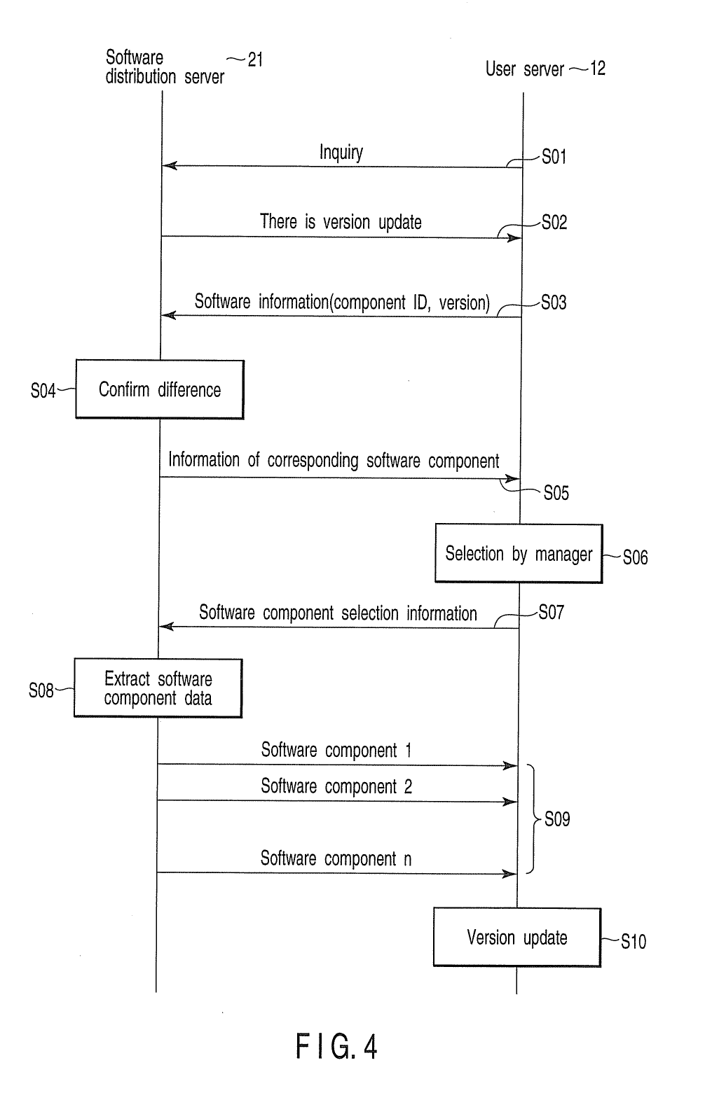

FIG. 4 is a flowchart showing procedures for updating the version of software by the information processing method according to the first embodiment of the invention.

In step S01, the user server 12 inquires about whether there is version update, to the software distribution server 21 in accordance with a periodic schedule. In step S02, the software distribution server 21 checks whether there is version update of software in a recent predetermined period. If there is version update, the software distribution server 21 sends a response that there is version update, to the user server 12.

Although not shown, if there is no version update, a response that there is no version update is sent to the user server 12. The user server 12, having received this response, stops the subsequent operations, and executes the operation from step S01 again after the lapse of a predetermined period. In this embodiment the user server 12 periodically inquires about whether there is version update. However, the software distribution server 21 may sends information that there is version update so that the subsequent operations can be executed.

In step S03, the user server 12 extracts, for example, component ID and version as information to univocally identify a software component from the software information in the database 17 and sends them to the software distribution server 21. In step S04, the software distribution server 21 compares the version which the software distribution server 21 itself manages for the software component, with the version sent thereto. Then, the software distribution server 21 extracts a software component which has a difference in version, and sends the component ID of the extracted software component to the user server 12 in step S05.

In step S06, the user server 12 displays a list of software components to be subjects of version update, on the display of the PC in accordance with the component ID sent thereto, and thus prompts the manager of the office 1 to carry out a selecting operation. When the manager of the office 1 has selected a desired software component to have its version updated, the component ID of the selected software component is sent to the software distribution server 21.

In step S08, the software distribution server 21 extracts a corresponding software component in accordance with the component ID sent thereto, and sends the extracted software component to the user server 12 in step S09. The user server 12 executes version update by using the software component sent thereto.

As the software components are subdivided in this manner, then the IDs and versions of the subdivided software components are sent and only a software component having a difference in version is sent and received, the volume of transmission can be reduced.

In this embodiment, in step S06, the manager selects a software component to have its version updated, but this selection may be automatically carried out.

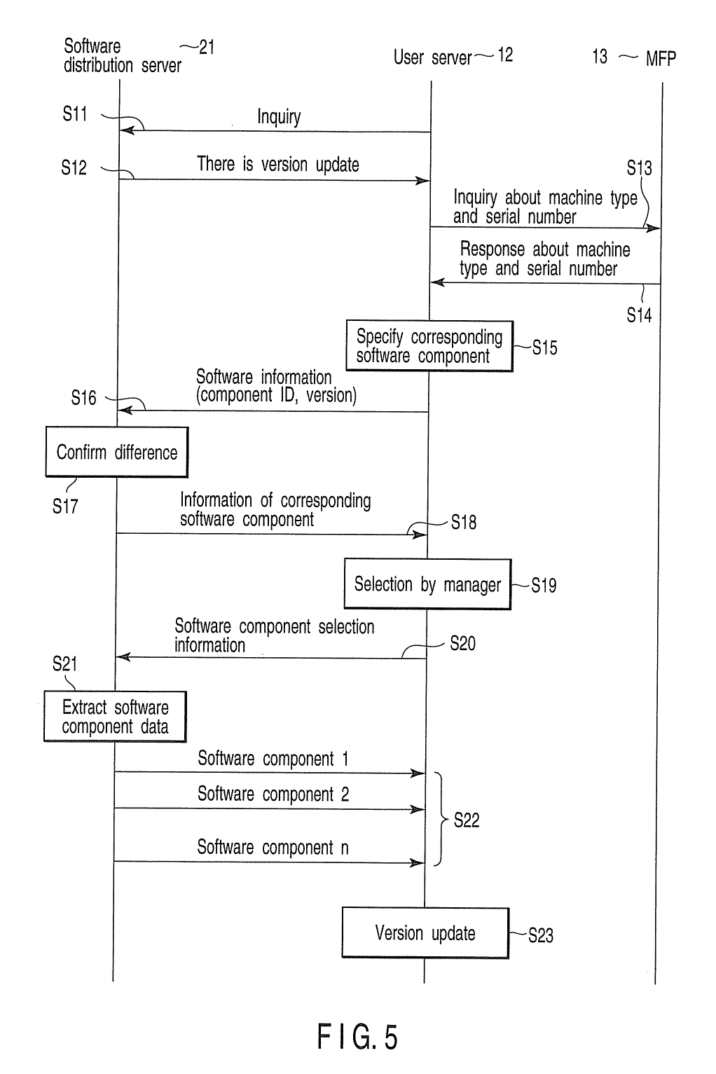

FIG. 5 is a flowchart showing procedures for updating the version of software by an information processing method according to a second embodiment of the invention. In the second embodiment, the same parts as in the first embodiment are denoted by the same reference numerals and will not be described further in detail.

In step S11, the user server 12 inquires about whether there is version update, to the software distribution server 21 in accordance with a periodic schedule. In step S12, the software distribution server 21 checks whether there is version update of software in a recent predetermined period. If there is version update, the software distribution server 21 sends a response that there is version update, to the user server 12.

In step S13, the user server 12 requests information about machine type and serial number from the MFP 13. When the information about machine type and serial number is sent from the MFP 13 in step S14, the user server 12 checks the software component which is being used by the MFP 13 having these machine type and serial number. Then, for example, the user server 12 specifies a corresponding software component from the software components shown in FIG. 3.

Here, the software components shown in FIG. 3 are classified into plural categories. Therefore, the same software component is included in plural categories. Thus, when specifying a software component, duplicate specification of the software component is avoided.

Then, in step S16, the user server 12 sends, for example, the component ID and version of the software component as information to univocally identify the specified software component, to the software distribution server 21. In step S17, the software distribution server 21 compares the version which the software distribution server 21 itself manages for the software component, with the version sent thereto. Then, the software distribution server 21 extracts a software component which has a difference in version.

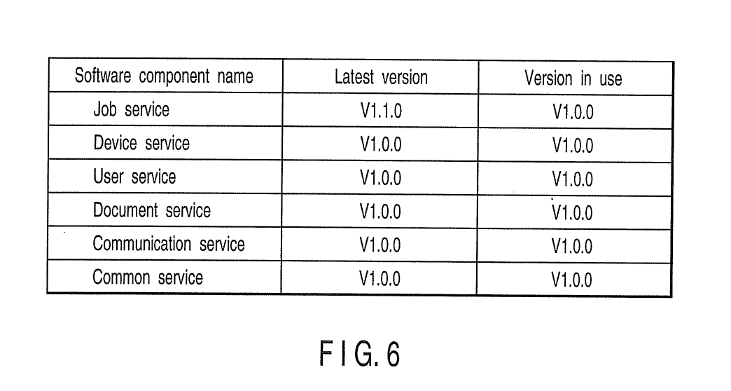

FIG. 6 is a view showing versions of software components. In FIG. 6, all the software components used in the office 1 are of version V1.0.0. Meanwhile, the latest version of a software component that can be used with this machine type is V1.1.0 for “Job Service”. Therefore, in the case where the latest service is to be used, “Job Service” is specified as a subject of version update.

However, since “Job Service” includes job components such as copy, scan, fax, and print, version management can be carried out on this level. That is, in the case where a new function is added to a part of scan functions, only the scan component is replaced to enable use of the new function. Thus, in this case, the software component related to the scan service is specified as a subject of update, and “Job Service” is not specified as a subject of update.

In step S18, the software distribution server 21 sends the component ID of the extracted software component to the user server 12.

The procedures of steps S19 to S23 are the same as the processing of steps S06 to S10 shown in FIG. 4 of the first embodiment and therefore will not be described further in detail.

In this manner, according to these procedures, a necessary software component is specified on the basis of the association between software components. Therefore, update of unnecessary software components can be avoided and efficient version update can be expected.

Also, according to these procedures, even in the case where addition or change is made to the functions of the MFP 13, a software component appropriate to that MFP 13 can be flexibly specified. For example, in the case where the MFP 13 is a color machine, addition or change can be made to the software component which controls color functions. In the case where option configuration of the MFP 13 differs, addition or change of software depending of an optical can be made. As a software component is thus specified in accordance with the machine type and version, update of software with respect to various configurations can be carried out flexibly and easily.

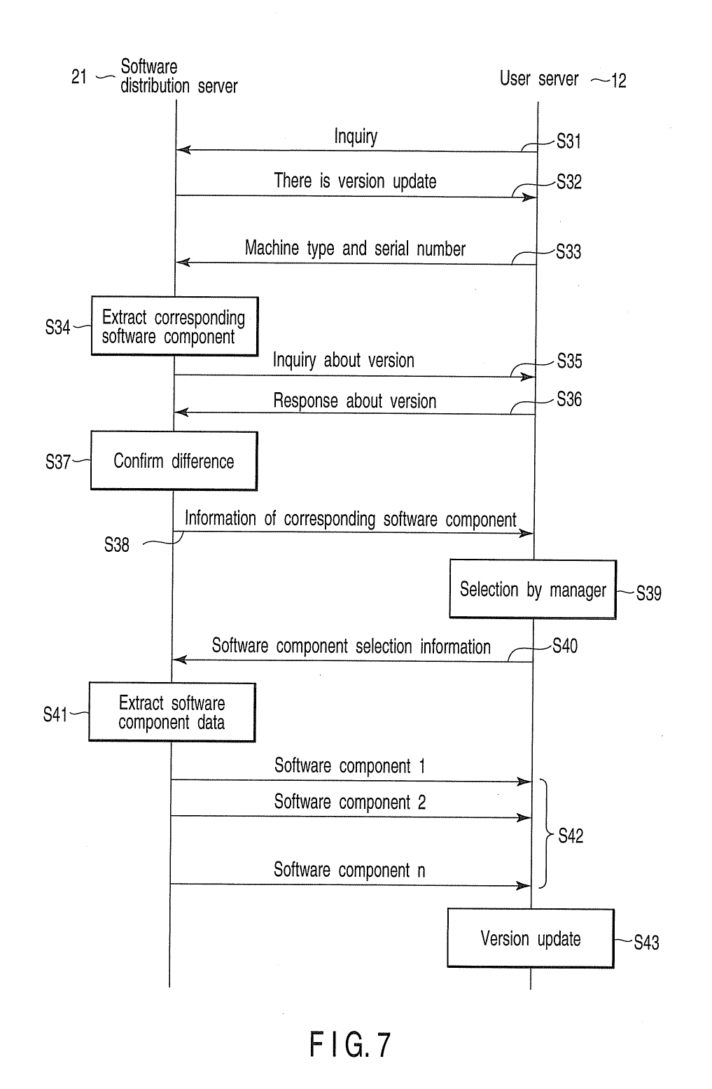

FIG. 7 is a flowchart showing procedures for updating the version of software by an information processing method according to a modification of the second embodiment of the invention.

In step S31, the user server 12 inquires about whether there is version update, to the software distribution server 21 in accordance with a periodic schedule. In step S32, the software distribution server 21 checks whether there is version update of software in a recent predetermined period. If there is version update, the software distribution server 21 sends a response that there is version update, to the user server 12.

In step S33, the user server 12 sends information about the machine type and serial number of the MFP 13 to the software distribution server 21. In step S34, the software distribution server 21 checks the software component which is being used by the MFP 13 on the basis of the information about the machine type and serial number. Then, for example, the software distribution server 21 specifies a corresponding software component from the software components shown in FIG. 3. Here, when specifying a software component, duplicate specification of the software component is avoided, as described with reference to FIG. 5 in the second embodiment.

Then, in step S35, the software distribution server 21 inquires about the version of the specified component in the office 1, to the user server 12. In step S36, the user server 12 sends the version information of the specified software component to the software distribution server 21.

In step S37, the software distribution server 21 compares the version which the software distribution server 21 itself manages for the software component, with the version sent thereto. Then, the software distribution server 21 extracts a software component which has a difference in version, and sends information to univocally identify the extracted software component, for example, component ID, to the user server 12 in step S38.

The procedures of steps S39 to S43 are the same as the processing of steps S06 to S10 shown in FIG. 4 of the first embodiment and therefore will not be described further in detail.

According to these procedures, similar advantages to those shown in FIG. 5 of the second embodiment can be achieved. However, unlike the second embodiment, the specification of the corresponding software component in step S34 is carried out by the software distribution server 21. The software distribution server 21 has higher processing capability than the user server 12 and can also have abundant device information about the MFP 13. Therefore, according to these procedures, the load on the user server 12 can be reduced and the software component can be specified more effectively.

In a configuration where the software of the user server 12 is installed in the MFP 13 and the MFP 13 is responsible for the functions of the above user server 12, the above-described advantages are particularly significant.

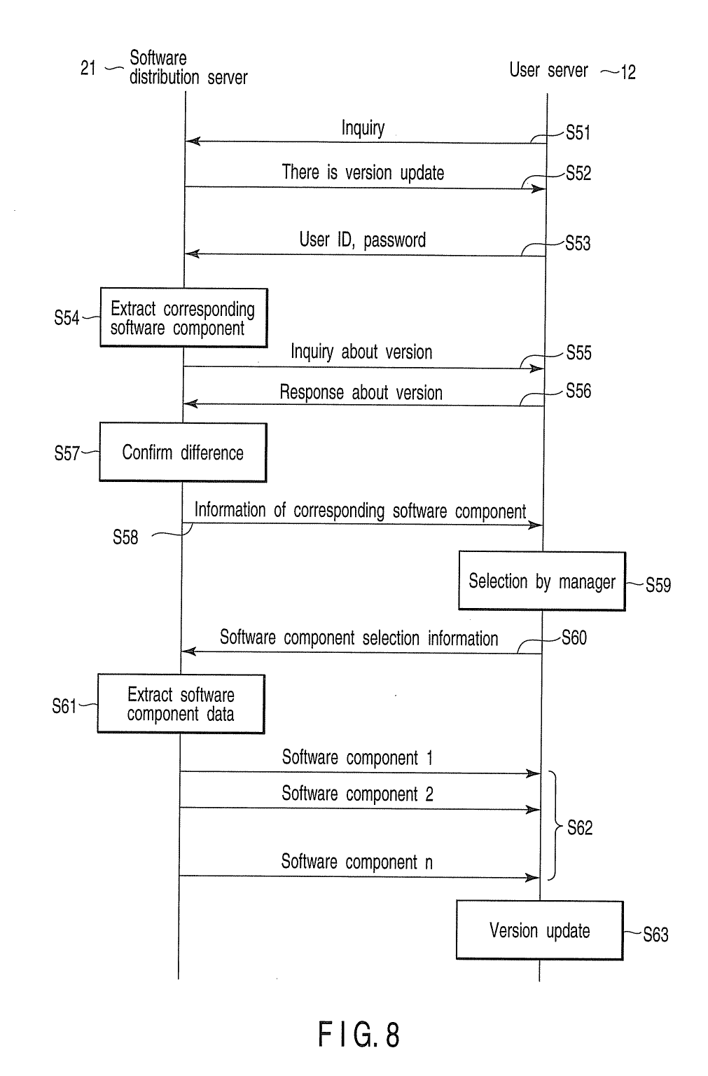

FIG. 8 is a flowchart showing procedures for updating the version of software by an information processing method according to a third embodiment of the invention. In the third embodiment, the same parts as in the first embodiment are denoted by the same reference numerals and will not be described further in detail.

In step S51, the user server 12 inquires about whether there is version update, to the software distribution server 21 in accordance with a periodic schedule. In step S52, the software distribution server 21 checks whether there is version update of software in a recent predetermined period. If there is version update, the software distribution server 21 sends a response that there is version update, to the user server 12.

In step S53, the user server 12 sends information about user ID and password which specify a user to the software distribution server 21. This user ID and password is information managed by the software distribution server 21. In step S54, the software distribution server 21 sends the information about the user ID and password to the service center authentication server 22.

The service center authentication server 22 authenticates the user on the basis of the user ID and password and sends information about machine time and serial number of the MFP 13 held by the user and information about contract to the software distribution server 21. In step S54, the software distribution server 21 checks the software component which is being used by the MFP 13 in accordance with the information about machine type and serial number and the information about contract with the user. Then, the software distribution server 21 specifies, for example, a corresponding software component from the software components shown in FIG. 3. Here, when specifying a software component, duplicate specification of the software component is avoided, as described with reference to FIG. 5 in the second embodiment.

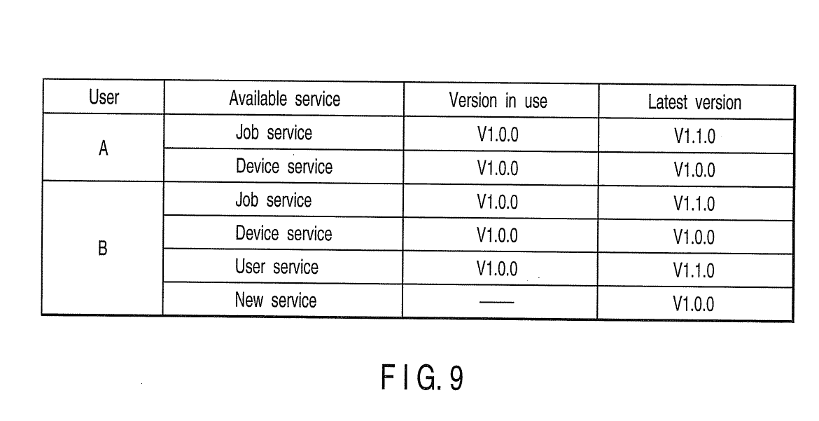

FIG. 9 is a view showing software components available to each user as the MFP 13. “Job Service” and “Device Service” are available to the user A. Of these, only the version of “Job Service” is updated. Therefore, in this case, it is determined that only “Job Service” must be updated.

On the other hand, “Job Service”, “Device Service” and “User Service” are available to the user B. Of these, the version of “Job Service” and “Device Service” is updated. Therefore, it is determined that these software components must be updated.

As the information about contract with the user is considered in this manner, not only “New Service” can be added when the user has changed the contract details and a new function is added to the MFP 13, but also the detailed services can be handled as subjects of update when these services are updated. Also, in the case where the user A does not need the “Job” function, the MFP 13 has only the “Device” function and only the “Device” function is a subject of update.

In step S55, the software distribution server 21 inquires about the version of the extracted software component in the office 1, to the user server 12. In step S56, the user server 12 sends version information to the software distribution server 21.

In step S57, the software distribution server 21 compares the version which the software distribution server 21 itself manages for the software component, with the version sent thereto. Then, the software distribution server 21 extracts a software component which has a difference in version, and sends the component ID of the extracted software component to the user server 12 in step S58.

The procedures of steps S59 to S63 are the same as the processing of steps S06 to S10 shown in FIG. 4 of the first embodiment and therefore will not be described further in detail.

According to these procedures, flexible software update corresponding to the contract in addition to the procedures shown in FIG. 7 can be realized.

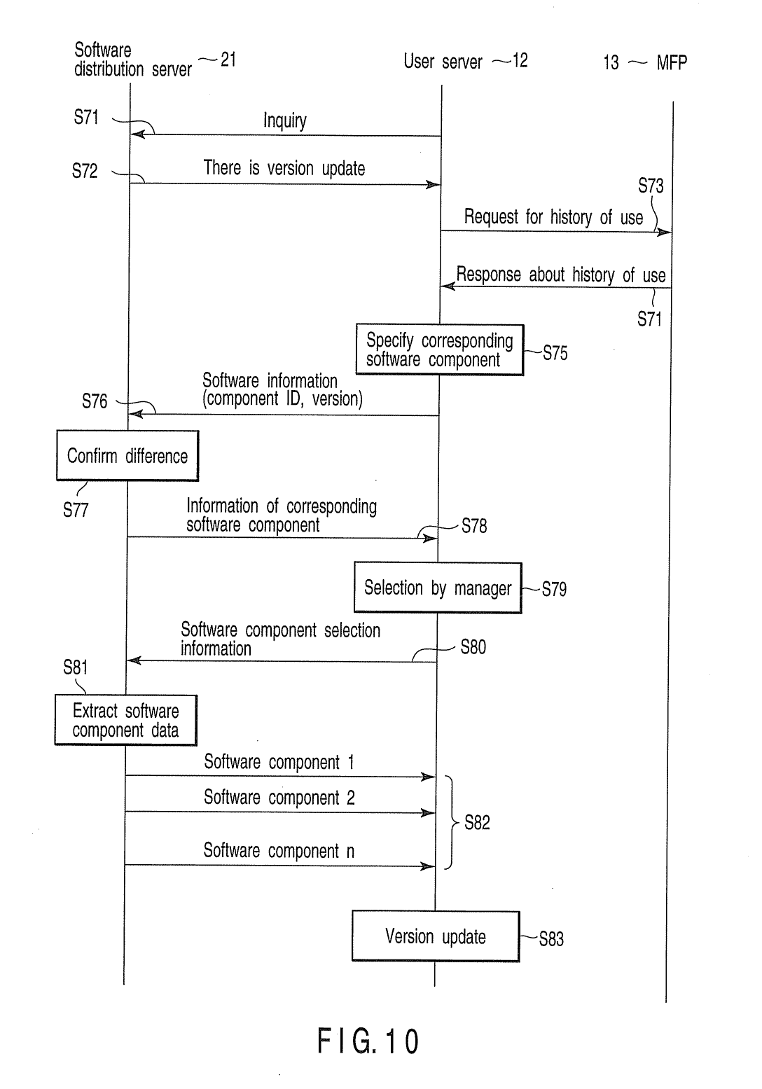

FIG. 10 is a flowchart showing procedures for updating the version of software by an information processing method according to a fourth embodiment of the invention. In the fourth embodiment, the same parts as in the first embodiment are denoted by the same reference numerals and will not be described further in detail.

In step S71, the user server 12 inquires about whether there is version update, to the software distribution server 21 in accordance with a periodic schedule. In step S72, the software distribution server 21 checks whether there is version update of software in a recent predetermined period. If there is version update, the software distribution server 21 sends a response that there is version update, to the user server 12.

In step S73, the user server 12 requests information about history of use of software components, from the MFP 13. Here, the history of use shows, for example, how many hours each software component is used within a predetermined period. This history of use is information managed by the MFP 13. In step S74, when the information about the history of use of software components is sent by the MFP 13, the user server 12 decides a software component to be updated and a software component which is not to be updated, on the basis of the history of use. For example, in the case where the time a software component is used is equal to or less than the time defined for each software, it is decided that the software component should not be updated. Otherwise, it is decided that the software component should be updated.

Then, in step S76, the component ID and version of the software component which is decided to be updated are sent to the software distribution server 21. In step S77, the software distribution server 21 compares the version which the software distribution server 21 itself manages for the software component, with the version sent thereto. Then, the software distribution server 21 extracts a software component which has a difference in version, and sends the component ID of the extracted software component to the user server 12 in step S78.

The procedures of steps S79 to S83 are the same as the processing of steps S06 to S10 shown in FIG. 4 of the first embodiment and therefore will not be described further in detail.

These procedures can be used in the following application. A department A of a company frequently uses copy and fax functions, and a department B frequently uses scan and print functions. In this case, available software functions are changed in accordance with the state of use of each function. For example, since the department A frequently uses the copy and fax functions, software components corresponding to them are updated and the user interface is switched to a user interface mainly for the copy and fax functions. Thus, software update to improve convenience for the user is carried out.

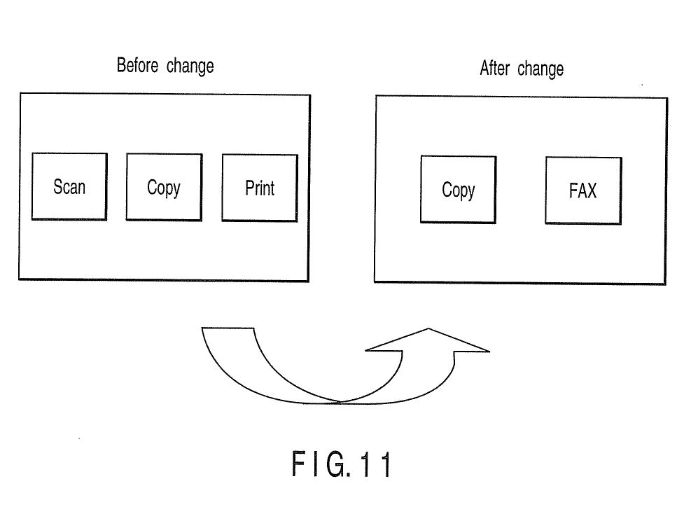

FIG. 11 is a view showing an example where the user interface is changed in this manner. “Scan” and “Print” shown in FIG. 11 represent button icons. “Scan”, “Copy” and “Print” button icons are displayed before change. After change, the display is changed to “Copy” and “FAX” button icons. As a measure of updating, the information itself which configures the user interface may be changed, or a setting file such as a meta file can be updated to make a changeover.

Also, in such a changeover operation, for example, a maintenance serviceman confirms the state of use and executes the operation when visiting the client. As this technique is applied in this manner, convenience for the user and easy customization can be secured.

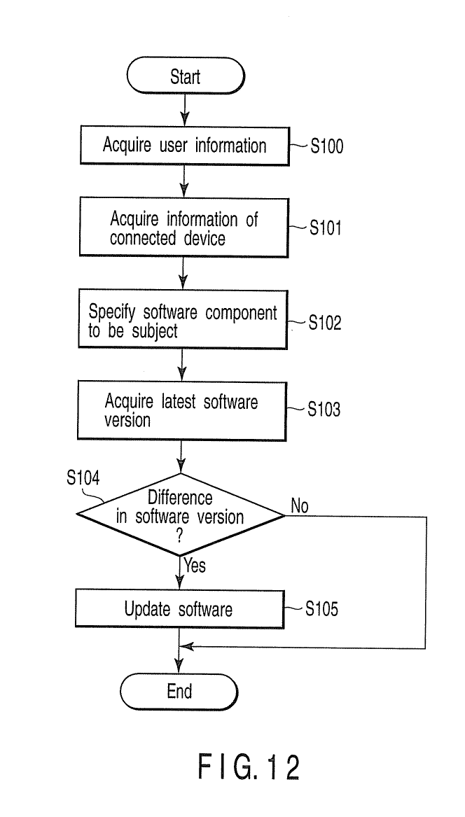

The procedures described with reference to FIG. 4 to FIG. 11 can be properly selectively adopted and executed as a combination. FIG. 12 is a view showing a representative processing flow of software version update. This flow shows a processing operation carried out by the user server 12 in cooperation with the software distribution server 21.

In step S100, information about a user, for example, about contract details, is acquired. In step S101, information about the device of the MFP 13, for example, machine type, serial number and the like, is acquired. In step S102, a software component to be a subject is specified in accordance with these pieces of information. In step S103, the current version and the latest version of the corresponding software component are compared with each other. If it is Yes in step S104, that is, if there is a difference in version, update of the software component is executed.

According to the above-described embodiments, a mechanism can be provided which can flexibly carry out change of software dependent on machine type of the device, addition and change of functions, and provision of software based on user's purpose. The machines types of devices installed in an office are diverse, and functions demanded by users vary, too. Even in such a circumstance, user's detailed requests can be dealt with, and therefore user's demands can be met quickly. It can contribute to improvement in customer satisfaction (CS), reduce the service cost on the product provider side, and further contribute to reduction in total cost (TCO). Thus, customization can be realized which is advantageous to both the user who uses this system and the provider who provides devices such as an MFP.

In the above embodiments, the user server 12 and the MFP 13 are separated. However, the functions of the user server 12 may be incorporated in the MFP 13. Also, while the software distribution server 21 distributes an update program in the above embodiments, the present invention is not limited to these embodiments. A serviceman may visit the office 1 where the MFP 13 is installed, and may connect a personal computer (PC) with the MFP 13 on site and send an update program from the PC to carry out updating.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing method for an information processing apparatus which acquires a software component controlling an image forming apparatus from an external device via a communication line and updates the software component,
wherein the software component is classified by function unit of the image forming apparatus, and the function unit is caused to correspond to information specifying a device of the image forming apparatus and information specifying a user using the image forming apparatus,
the method comprising:
sending information to univocally identify the software component to the external device,
acquiring information about a software component to be a subject of update on the basis of the information to univocally identify the software component from the external device,
sending information about a software component selected from the software components corresponding to the acquired information to the external device,
acquiring software component data sent from the external device in accordance with the information about the selected software component, and
updating the corresponding software component of the image forming apparatus, using the acquired software component data.

2. The information processing method according to claim 1, wherein the information to univocally identify the software component which is sent to the external device is ID information and version of a software component provided in the image forming apparatus.

3. The information processing method according to claim 1, wherein the software component according to the information to univocally identify the software component which is sent to the external device is a software component caused to correspond to the information specifying the device of the image forming apparatus.

4. The information processing method according to claim 1, wherein the software component according to the information to univocally identify the software component which is sent to the external device is a software component caused to correspond to the information specifying the device of the image forming apparatus and caused to correspond to the information specifying the user using the image forming apparatus.

5. The information processing method according to claim 1, wherein the software component according to the information to univocally identify the software component which is sent to the external device is a software component such that an operating time of each of the software components of the image forming apparatus in a predetermined period is more than a reference time of each.

6. An information processing method for an information processing apparatus which acquires a software component controlling an image forming apparatus from an external device via a communication line and updates the software component,
wherein the software component is classified by function unit of the image forming apparatus, and the function unit is caused to correspond to information specifying a device of the image forming apparatus and information specifying a user using the image forming apparatus,
the method comprising:
sending the information specifying the device of the image forming apparatus to the external device,
sending version of a software component in response to an inquiry about the version of the software component specified in the external device on the basis of the information specifying the device,
acquiring information about a software component to be a subject of update which is further specified in the external device on the basis of the version from the external device,
sending information about a software component selected from the software components corresponding to the acquired information to the external device,
acquiring software component data sent from the external device, and
updating the corresponding software component of the image forming apparatus using the acquired software component data.

7. An information processing method for an information processing apparatus which acquires a software component controlling an image forming apparatus from an external device via a communication line and updates the software component,
wherein the software component is classified by function unit of the image forming apparatus, and the function unit is caused to correspond to information specifying a device of the image forming apparatus and information specifying a user using the image forming apparatus,
the method comprising:
sending the information specifying the user using the image forming apparatus to the external device,
sending version of a software component, in response to an inquiry about the version of the software component specified in the external device on the basis of the information specifying the user,
acquiring information about a software component to be a subject of update which is further specified in the external device on the basis of the version from the external device,
sending information about a software component selected from the software components corresponding to the acquired information to the external device,
acquiring software component data sent from the external device, and
updating the corresponding software component of the image forming apparatus using the acquired software component data.

8. A recording medium having recorded therein an information processing program for an information processing apparatus which acquires a software component controlling an image forming apparatus from an external device via a communication line and updates the software component,
wherein the software component is classified by function unit of the image forming apparatus, and the function unit is caused to correspond to information specifying a device of the image forming apparatus and information specifying a user using the image forming apparatus,
the program causing the image forming apparatus to execute the steps of:
sending information to univocally identify the software component to the external device;
acquiring information about a software component to be a subject of update on the basis of the information to univocally identify the software component from the external device;
sending information about a software component selected from the software components corresponding to the acquired information to the external device;
acquiring software component data sent from the external device in accordance with the information about the selected software component; and
updating the corresponding software component of the image forming apparatus using the acquired software component data.
